(19) United States
(12) Patent Application Publication
(10) Pub. No.: US 2025/0391177 A1
(43) Pub. Date: Dec. 25, 2025

(54) RELIABLE OBSTACLE DETECTION

(71) Applicant: Continental Autonomous Mobility Germany GmbH, Ingolstadt (DE)

(72) Inventors: Martin Pfitzer, Lindau (DE); Stefan Heinrich, Achern (DE); Thomas Fechner, Wasserburg (DE)

(73) Assignee: Continental Autonomous Mobility Germany GmbH, Ingolstadt (DE)

(21) Appl. No.: 19/124,148

(22) PCT Filed: Sep. 25, 2023
(86) PCT No.: PCT/DE2023/200200

§ 371 Date: Apr. 24, 2025

(30) Foreign Application Priority Data
Oct. 24, 2022 (DE) 10 2022 211 236.9

(51) Int. Cl. G06V 20/58; G06V 10/82

(52) U.S. Cl. CPC G06V 20/58; G06V 10/82

(57) ABSTRACT

A method for detecting an obstacle includes providing a first image from a first camera with a first field of view and providing a second image from a second camera with a second field of view, wherein the first and the second field of view at least partially overlap. A disparity map is established according to the first and/or the second image. The disparity map and at least one of the at least two images are provided as input for a trained neural network which is configured to provide a statement regarding the presence of an obstacle in the field of view of at least one of the two cameras according to the input. The method also includes outputting the statement regarding the presence of the object in the field of view of at least one of the two cameras.

### CROSS-REFERENCE TO RELATED APPLICATIONS

The present application is a National Stage Application under 35 U.S.C. § 371 of International Patent Application No. PCT/DE2023/200200 filed on Sep. 25, 2023, and claims priority from German Patent Application No. 10 2022 211 236.9 filed on Oct. 24, 2022, in the German Patent and Trademark Office, the disclosures of which are herein incorporated by reference in their entireties.

### TECHNICAL FIELD

The technical field relates to a method, in particular a computer-implemented method, for detecting an obstacle of a vehicle.

### BACKGROUND

Modern vehicles frequently have advanced driver assistance systems (ADAS) to support the driver of the vehicle. In this context, various ADAS functions have become known. These can, on the one hand, be used to support the driver while the control over the vehicle while driving remains with the driver. On the other hand, however, fully automated driving can be realized.

One ADAS function which is of central importance is the detection of obstacles on the road. In this context, obstacles can be various objects on the road, in particular scree, lost freight items or the like. However, many other obstacles in the front region of the respective, in particular driving, car can be problematic.

In order to detect obstacles, different sensor systems integrated in the vehicle, such as radar or lidar sensors, or cameras can be used. One advantage of cameras is that they provide high spatial resolution at a comparatively low cost. In particular stereo or multi-camera systems are increasing in popularity in connection with ADAS functions. One disadvantage of such camera systems, however, is that they provide a comparatively low degree of precision for distance measurement, in particular for greater distances. However, knowledge of the distance is crucial in order to be able to detect obstacles in time and initiate corresponding actions to drive around them.

In many cases, image analysis of camera images for obstacle detection is performed according to traditional object detection methods and trainable neural networks. However, typical object detection methods vary in precision depending on the objects to be detected. As such, detecting obstacles is particularly problematic when the obstacles are not standard objects such as other vehicles. As described above, various objects can be obstacles on a road, including lost freight items with various sizes and geometric dimensions. This is a fundamental problem for using classifiers, in particular when using methods of machine learning. The precision of the image analysis is in this case crucially dependent on the availability of different training data.

In order to detect different obstacles, the article “Lost and Found: Detecting Small Road Hazards for Self-Driving Vehicles”0 by P. Pinggera et al., published in 2016 IEEE/RSJ International Conference on Intelligent Robots and Systems (IROS), 2016, p. 1099-1106 (doi: 10.1109/IROS.2016.7759186) proposes a fusion of a semantic segmentation with a convolutional neural network (CNN) and images of a stereo camera for obstacle detection. In this way, elevated structures on the road can be identified based on a stereo camera image.

By contrast, in “Depth Not Needed-An Evaluation of RGB-D Feature Encodings for Off-Road Scene Understanding by Convolutional Neural Network” by C. J. Holder et al., published on arxiv.org, 2018(https://arxiv.org/ftp/arxiv/papers/1801/1801.01235.pdf) a combination of RGB images and disparity images is proposed. However, with this method, the disparity images are established based on calibrated camera images. Therefore, complex camera calibration is always necessary. Additionally, a rectification of the image data from the respective camera must be performed in order to reliably detect obstacles.

As such, both mentioned methods have the disadvantage that they require complex algorithms for detecting the obstacles according to the camera images.

A simple, robust method for detecting obstacles would be desirable. Therefore, it is the object of the present disclosure to provide simple and precise obstacle detection with which any objects on the road can be detected by with images captured from one or multiple cameras.

### SUMMARY

A method, in particular computer-implemented, method for detecting an obstacle is disclosed herein. The method includes:
providing a first image from a first camera with a first field of view,
providing a second image from a second camera with a second field of view, wherein the first and the second field of view at least partially overlap,
establishing a disparity map according to the first and/or the second image,
providing a disparity map and at least one of the at least two images as input for a trained neural network which is configured to provide a statement regarding the presence of an obstacle in the field of view of at least one of the two cameras according to the input, and
outputting the statement regarding the presence of the object in the field of view of at least one of the two cameras.

The first and the second camera can be part of a camera system having at least two cameras, in particular part of a stereo camera system. However, they can also be two cameras separately mounted on the same vehicle. In one embodiment, the first and/or the second camera are attached to a vehicle. The cameras can be part of an advanced driver assistance system.

The first and/or the second image from the first and/or the second camera can be a black-and-white image or a color image. In the latter case, different color spaces, for example additive color spaces such as the red-green-blue (RGB) color space can be used.

The disparity map describes a shift between two inter-corresponding pixels in the first and the second image from the first and the second camera.

The neural network can, for example, be trained with training data with images in which obstacles are marked. The trained network is then able to detect those pixels in the first and/or the second image from the first and/or the second camera which belong to an obstacle object class. Advantageously, any obstacles on the road can be identified with the method described herein.

The statement regarding the presence of an obstacle in the field of view of at least one of the two cameras can be different statements about one obstacle. For example, it can be detected if obstacles are present in the field of view of at least one of the two cameras and the coordinates of the obstacles can be outputted; however, it is also conceivable to detect the type of obstacle or the size and/or distance of the obstacle from the camera. However, other statements about obstacles are also conceivable and fall within the scope of the present disclosure.

The method described herein is notable by its low degree of algorithmic complexity. Nevertheless, precise obstacle detection is possible, because the disparity map enables a statement about the distance and size of the respective objective, even if disparity data are not typically referenced for determining a distance of an object. In particular, the use of a disparity map decreases the degree of algorithmic complexity significantly.

For the method described herein, it is further advantageous that a calibration, in particular an online calibration, of the first and/or the second camera or a rectification of the camera images is not necessary.

In a configuration of the method, the neural network is a convolutional neural network, a recurrent neural network, a hypernetwork or a transformer network.

In a further configuration, the neural network is configured to output an obstacle map corresponding to the first and/or second image, said obstacle map containing information regarding the presence of the obstacle in the first and/or second image. In this way, the statement regarding the obstacle can be suitably made more precise. For example, using the obstacle map, the position of an obstacle or of several obstacles, in particular relative to the vehicle, can be detected.

In this context, it is advantageous when, for predeterminable subareas, in particular for each pixel, of the first and/or second image, the obstacle map indicates whether the subarea is part of an obstacle.

It is further advantageous when each subarea of the obstacle map is associated with one of at least two predeterminable association values, wherein a first association value is assigned when the subarea is part of an obstacle and wherein a second association value is assigned when the subarea is not part of the obstacle, meaning when it is, e.g., a background, an object off of the road or the like. However, more than two association values can also be defined.

For example, a first association value can be assigned to the road, a second association value can be assigned to areas off the road, and a third association value can be assigned to an obstacle in the area of the road. Therefore, a further classification according to the images from the first and the second camera is also possible, the classification extending beyond the basic presence of obstacles in the field of view of at least one camera.

A configuration of the method described herein includes that the disparity map is established for the second image under consideration of the first image and/or for the first image under consideration of the second image.

A further configuration includes that the disparity map is established by a non-linear correlation, in particular according to a cross-correlation, such as a zero-mean, normalized cross-correlation, by utilizing a two-dimensional, block matching algorithm or a semi-global matching algorithm.

In a one configuration, the disparity map is established utilized a trained neural network, the network being configured to determine the disparity map at least according to the first and the second image. The neural network may be a convolutional neural network, a recurrent neural network, a hypernetwork, or a transformer network. Establishing the disparity map utilizing a neural network is particularly robust and dense and thus particularly suitable for determining a statement regarding the obstacle.

In particular regarding the complexity of the method, it is advantageous when a neural network, in particular the same type of neural network, is used for establishing the disparity map and for determining a statement regarding the obstacle. Advantageously, similar architectures can be used for the two networks in this case.

In one configuration of the method, a two-dimensional disparity map is established. In this case, each pixel is assigned two disparity values, for example one for a lateral displacement and one for a vertical displacement.

The object described herein may also be achieved by a computer program with instructions which, when the computer program is run by a computer, cause the computer to perform the method according to any one of the described configurations.

The object described herein may also be achieved by a computer program product on which the computer program according to the invention is stored.

### BRIEF DESCRIPTION OF THE DRAWINGS

The disclosure as well as its advantageous features are described in further detail as follows:

FIG. 1 illustrates a camera system of a vehicle for implementing a method according to the disclosure.

### DETAILED DESCRIPTION

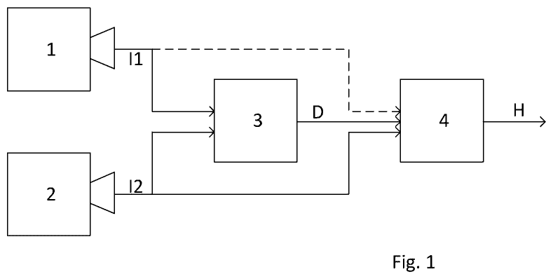

Referring to FIG. 1, two cameras 1, 2 are shown with partially overlapping fields of view. In order to establish a statement regarding the presence of an obstacle H, a first image I1 from the first camera 1 and a second image I2 from the second camera are provided to a unit 3 for establishing a disparity map D.

At least one of the two images I1, I2—in this case the second image I2 from the second camera 2—is provided together with the disparity map as input for the neural network 4. This neural network 4 is configured to make and output the statement regarding the presence of an obstacle H in the field of view of at least one of the two cameras 1, 2—in this case the second camera 2—according to the input. In place of the second image I2, the first image I1 can also be provided to the neural network 4 as input (dotted line) or both images I1 and I2 can serve as input.

A prior rectification of the images I1 and I2 before establishing the disparity map D is not necessary. It is a central notion of the invention that object detection can be realized by means of such a disparity map D with the aid of a neural network 4. According to the state of the art, however, a rectification step must always be performed first in order to be able to perform obstacle detection.

Different methods for establishing the disparity map are conceivable and lie within the scope of the present disclosure. Establishing a two-dimensional disparity map is particularly preferable. In this context, on the one hand, any suitable mathematic correlation function, in particular a cross correlator, can be referenced. However, it is equally conceivable for a neural network to also be used for establishing the disparity map D which may be a convolutional neural network (CNN). Two-dimensional correlations can be particularly well established with a convolutional neural network. Then, it is further preferable when the neural network 4 is also a convolutional neural network (CNN). In this case, a similar architecture can be used for the two networks.

In summary, the method described herein as well as the corresponding computer program and computer program product allow for particularly robust obstacle detection, in particular in the context of advanced driver assistance systems for vehicles. The method constitutes a simplification of the state of the art, as no prior processing of the camera images, for example rectification, is needed. Rather, it is possible to use the raw data images from the cameras 1 and 2 directly. However, the on the other hand advantageous and generally complex correlation can be very efficiently and precisely managed, for example with the aid of a neural network, in particular a convolutional neural network (CNN).

1. A computer-implemented method, for detecting an obstacle, comprising:
providing a first image from a first camera with a first field of view,
providing a second image from a second camera with a second field of view, wherein the first field of view and the second field of view at least partially overlap,
establishing a disparity map according to the first image and/or the second image
providing a disparity map and at least one of the at least two images as input for a trained neural network which is configured to provide a statement regarding the presence of an obstacle in the field of view of at least one of the two cameras according to the input, and
outputting the statement regarding the presence of the object in the field of view of at least one of the two cameras.

2. The method according to claim 1, wherein the neural network is at least one of a convolutional neural network, a recurrent neural network, a hypernetwork, and a transformer network.

3. The method according to claim 1, wherein the neural network is configured to output an obstacle map corresponding to the first image and/or second image, the obstacle map containing information regarding the presence of the obstacle in the first image and/or the second image.

4. The method according to claim 3, wherein, for predeterminable subareas, of the first and/or second image, the obstacle map indicates whether the subarea is part of an obstacle.

5. The method according to claim 4, wherein each subarea of the obstacle map is associated with one of at least two predeterminable association values, wherein a first association value is assigned when the subarea is part of an obstacle and wherein a second association value is assigned when the subarea is not part of the obstacle.

6. The method according to claim 1, wherein the disparity map is established for the second image under consideration of the first image and/or for the first image under consideration of the second image.

7. The method according to claim 1, wherein the disparity map is established utilizing a zero-mean, normalized cross-correlation, with at least one of a two-dimensional, block matching algorithm or and a semi-global matching algorithm.

8. The method according to claim 1, wherein the disparity map is established utilizing a trained neural network, the network being configured to determine the disparity map at least according to the first and the second image.

9. The method according to claim 1,
wherein a two-dimensional disparity map is established.

10. (canceled)

11. (canceled)
